(19) United States
(12) Patent Application Publication
(10) Pub. No.: US 2005/0198269 A1
(43) Pub. Date: Sep. 8, 2005

(54) Method and system for monitoring border gateway protocol (BGP) data in a distributed computer network

(76) Inventors: Andrew F. Champagne, Ware, MA (US); Harald Prokop, Cambridge, MA (US); Rizwan S. Dhanidina, Allston, MA (US); William E. Weihl, San Francisco, CA (US)

Correspondence Address: David H. Judson;Locke Liddell & Sapp LLP, Suite 2200, 2200 Ross Avenue, Dallas, TX, 75201-6776, US

(21) Appl. No.: 10/778,484

(22) Filed: Feb. 13, 2004

(51) Int. Cl. G06F 15/173

(52) U.S. Cl. 709/224; 709/245

(57) ABSTRACT

A Border Gateway Protocol (BGP) monitoring service is described. The monitoring service receives as input(s) configuration data input from one or more site(s) that desire to obtain the service, as well as BGP feed data received from a set of data collectors positioned at or adjacent BGP peering points. For every origin (IP space) being monitored, a monitoring application monitors a set of allowed or permitted originating Autonomous System (AS) numbers for that space. Thus, for every IP address space being watched (i.e., for each routable block that contains an origin server IP address of interest), the monitoring application continually monitors the set of transit Autonomous Systems for that CIDR block. Using the real-time BGP feeds (and/or the daily updates), the monitoring application looks for updates coming from the routers that impact the CIDR blocks of interest for that particular site(s). When a variance occurs, the monitoring application sends a message to an alerts system, which then issues a notification to the affected user or takes some other control action. Thus, for example, when a route to a network IP range being tracked is advertised from within some other network, the service identifies where the advertisement originates. This enables the site to detect potential BGP-based attacks and to respond accordingly.

### BACKGROUND OF THE INVENTION

1. Technical Field

The present invention relates generally to methods and system for reporting and responding to network security incidents, such as those involving Border Gateway Protocol (BGP).

2. Description of the Related Art

Border Gateway Protocol (BGP) is the most critical, highest-level routing protocol on the Internet. It enables networks to communicate with each other and find appropriate paths across the wide-area Internet. BGP operates between routers that sit on the edges of backbones, ISPs, corporations, and other networks, whereby these routers advertise which routes they can reach through or within their networks. There are several problems with BGP, however, that have not received much attention but that create substantial risk to the online enterprise.

BGP currently has no built-in reporting mechanisms or security enhancements. There are efforts under way to step up security around BGP, but BGP is implemented on thousands of routers built by many vendors with multiple implementations of BGP software—on thousands of different networks. Any security enhancement can only be done on a vendor-specific or implementation-specific level, and must be implemented by each network independently—providing no solid guarantee of BGP security. BGP also incorporates virtually no reporting mechanisms, making troubleshooting and optimizations very difficult. In addition, BGP can be manually manipulated by complex rules on each network's equipment.

Due to its security vulnerabilities, there are many ways to intentionally or unintentionally exploit or break the protocol's operation. Indeed, many major enterprises have experienced incidents as a result of the protocol's lack of security and reporting capabilities, often resulting in hours of downtime for the entire online operations of the enterprise affected. As an example, consider if one network mistakenly advertises a route to an organization's IP addresses from their network using BGP. These advertisements can override the existing BGP paths identified to reach those IP addresses—effectively making those organizations unreachable on the Internet. Due to the propagation and convergence delays in BGP, the problematic advertisement would not be traceable or addressable through troubleshooting for a long period of time—possibly several hours—resulting in complete downtime for the enterprise's IP routing. In such a case, all online services would be disrupted, potentially resulting in millions of dollars of online revenue losses.

Hackers can also exploit BGP to cause severe damage and theft of customer data. Mistakes in network configuration are the root of many mishaps with BGP, causing critical downtime that cannot be traced easily. Outside of network configuration, the opportunity also exists to easily disrupt and steal online traffic by purposely manipulating BGP. Hundreds of routers across the Internet are known to have been compromised on many occasions, and numerous individuals and groups have easy access to BGP route injection. If a malicious individual were to advertise an organization's IP space, it could have terrible local and global implications.

A user falsely advertising a route to an organization's IP space triggers all IP traffic, including Web, e-mail, and all other higher-level protocols, to be routed to their infrastructure. Spammers often use this mechanism to create a false network presence from which to launch massive spam campaigns, after which they disappear and cannot be traced except to the IP address that they “hijacked.” If a determined hacker put up a fake version of an organization's Web portal on some infrastructure and “hijack” customer traffic through BGP manipulations, the hacker could steal user login and password information easily. On top of this, a malicious attacker can send seemingly legitimate e-mails to customers, intercept incoming e-mail transmissions, and disrupt the entire online presence of an organization.

It would be highly desirable to be able to provide techniques to rapidly identify and respond to any BGP-related incident, including misconfigurations by other networks, manually blocked route advertisements or withdrawals, problems with the protocol's proper functioning, and outright malicious theft of network traffic. The present invention addresses this problem.

### BRIEF SUMMARY OF THE INVENTION

It is an object of the present invention to detect performance discrepancies and churn in BGP data.

It is yet another object of the invention to identify and prevent BGP-based attacks by which entities can transparently divert all, or a subset, or a site's Internet Protocol (IP) traffic to a given region of the Internet.

A further object of the present invention is to provide a means to detect BGP-based attacks and to provide the ability to respond appropriately, thereby limiting potential damage to an entity's online presence.

It is a further more general object of the present invention to provide an entity having an online business presence with detailed, unique data about the security and health of an Internet Protocol (IP) space.

It is still a further object of the invention to facilitate reporting and analysis of various types of BGP-related incidents that otherwise may be undetectable.

A more specific object is to provide techniques to identify and respond to any BGP-related incident, including misconfigurations by other networks, manually blocked route advertisements or withdrawals, problems with the protocol's proper functioning, and outright malicious theft of network traffic.

In a representative embodiment, a Border Gateway Protocol (BGP) monitoring service is described. The monitoring service receives as input(s) configuration data input from one or more site(s) that desire to obtain the service, as well as BGP feed data received from a set of data collectors positioned at or adjacent BGP peering points. For every origin (IP space) being monitored, a monitoring application monitors a set of allowed or permitted originating Autonomous System (AS) numbers for that space. Thus, for every IP address space being watched (i.e., for each routable block that contains an origin server IP address of interest), the monitoring application continually monitors the set of transit Autonomous Systems for that CIDR block. Using the real-time BGP feeds (and/or the daily updates), the monitoring application looks for updates coming from the routers that impact the CIDR blocks of interest for that particular site(s). When a variance occurs, the monitoring application sends a message to an alerts system, which then issues a notification to the affected user or takes some other control action. Thus, for example, when a route to a network IP range being tracked is advertised from within some other network, the service identifies where the advertisement originates. This enables the site to detect potential BGP-based attacks and to respond accordingly.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a block diagram illustrating normal traffic flow into and out of an IP infrastructure;

FIG. 2 illustrates what may happen when a malicious entity hijacks a given network in a manner that may be transparent to a site's IP infrastructure;

FIG. 3 is a distributed computer network in which the BGP monitoring service of the present invention is implemented;

FIG. 4 illustrates a typical machine configuration used in the distributed computer system;

FIG. 5 illustrates a preferred embodiment of the invention wherein a set of machines in a distributed network include data collectors that provide periodic and real-time views of BGP data across the network;

FIG. 6 illustrates a representative interface by which a user of the present invention enters an IP range it wishes to monitor;

FIG. 7 illustrates a representative interface by which a user of the present invention can monitor the BGP activity across a variety of different Autonomous Systems;

FIG. 8 is a representative graph illustrating BGP churn over a given time period for a specific AS number;

FIG. 9 is a representative display tool by which a user of the invention may identify CIDR blocks associated with a particular AS number and the numbers connected to a particular IP address through BGP; and

FIG. 10 is a block diagram illustrating the BGP monitoring service according to the preferred embodiment of the present invention.

### DETAILED DESCRIPTION OF THE PREFERRED EMBODIMENT

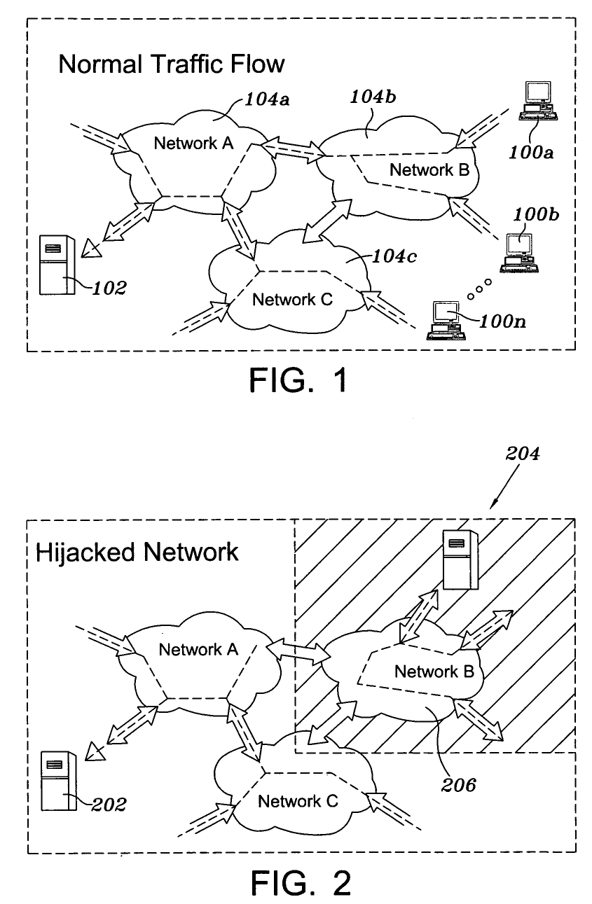

FIG. 1 displays how Internet Protocol (IP) internetwork traffic normally flows across the public Internet when the Border Gateway Protocol (BGP) is operating properly. Traffic between end users 100a-n and the Web server 102 passes between and through several networks 104a-c, but it always reaches its intended destination. Because routing information is not verified, however, a hacker or other malicious entity can “steal” traffic destined from a legitimate requester. This situation is illustrated in FIG. 2, where a malicious Web server 204 is sending and receiving data from a stolen IP space 206. The infrastructure of Web server 202, however, is not aware that this BGP-based IP hijacking is taken place. The present invention provides a “BGP” monitoring service to enable a site to have a view of such attacks and to respond to such attacks.

For purposes of illustration, the present invention is implemented in a distributed computer system, preferably a distributed system operated and managed by a given service provider. The service provider may provide the service on its own behalf, or on behalf of third parties. The invention may be implemented as a product, a service, a managed service, or by some combination thereof. It is known in the prior art that a “distributed system” typically refers to a collection of autonomous computers linked by a network or networks, together with the software, systems, protocols and techniques designed to facilitate various services, such as content delivery or the support of outsourced site infrastructure. Again, for purposes of illustration only, it is assumed that the inventive BGP monitoring service is implemented by a service provider that also provides its customers with such services as content delivery and/or outsourced site infrastructure. As used herein, “content delivery” means the storage, caching, or transmission of content, streaming media and applications on behalf of content providers, including ancillary technologies used therewith including, without limitation, request routing, provisioning, data monitoring and reporting, content targeting, personalization, and business intelligence. The term “outsourced site infrastructure” means the distributed systems and associated technologies that enable an entity to operate and/or manage a third party's Web site infrastructure, in whole or in part, on the third party's behalf.

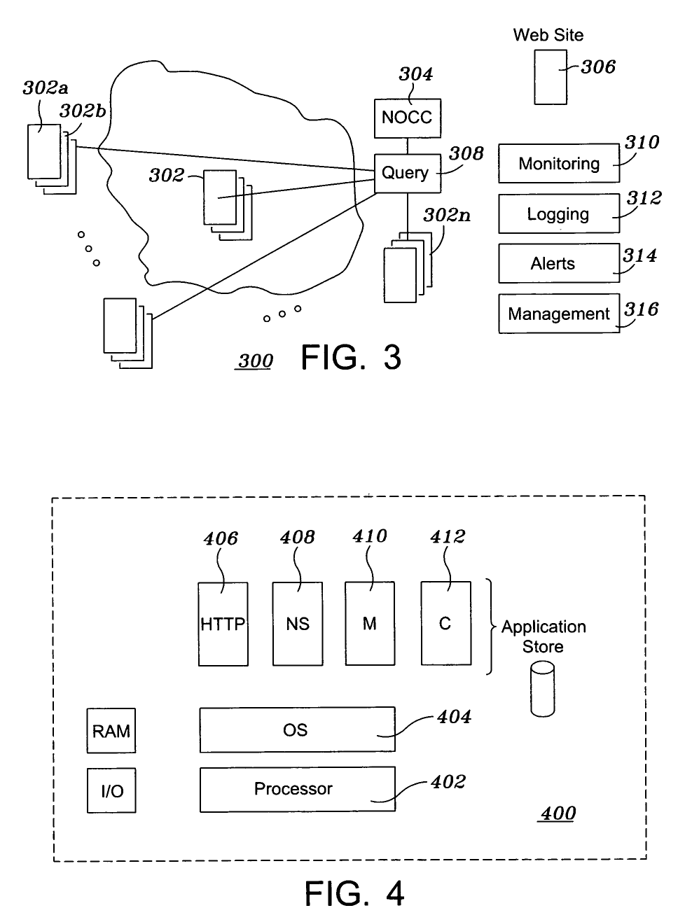

As illustrated in FIG. 3, a distributed computer system 300 is assumed to have a set of machines 302a-n distributed around the Internet. Typically, most of the machines are servers located near the edge of the Internet, i.e., at or adjacent end user access networks. A Network Operations Command Center (NOCC) 304 may be used to administer and manage operations of the various machines in the system. Third party sites, such as Web site 306, offload delivery of certain content to the distributed computer system 300 and, in particular, to “edge” servers. End users that desire such content may be directed to the distributed computer system to obtain that content more reliably and efficiently. Although not shown in detail, the distributed computer system may also include other infrastructure, such as a distributed data query and collection system 308 that collects usage and other data from the edge servers, aggregates that data across a region or set of regions, and passes that data to other back-end systems 310, 312, 314 and 316 to facilitate monitoring, logging, alerts, billing, management and other operational and administrative functions. As illustrated in FIG. 4, a given machine 400 comprises commodity hardware (e.g., an Intel Pentium processor) 402 running an operating system kernel (such as Linux) 404 that supports one or more applications 406a-n. To facilitate content delivery services, for example, given machines typically run a set of applications, such as an HTTP Web proxy 406, a name server 408, a local monitoring process 410, a distributed data collection process 412, and the like.

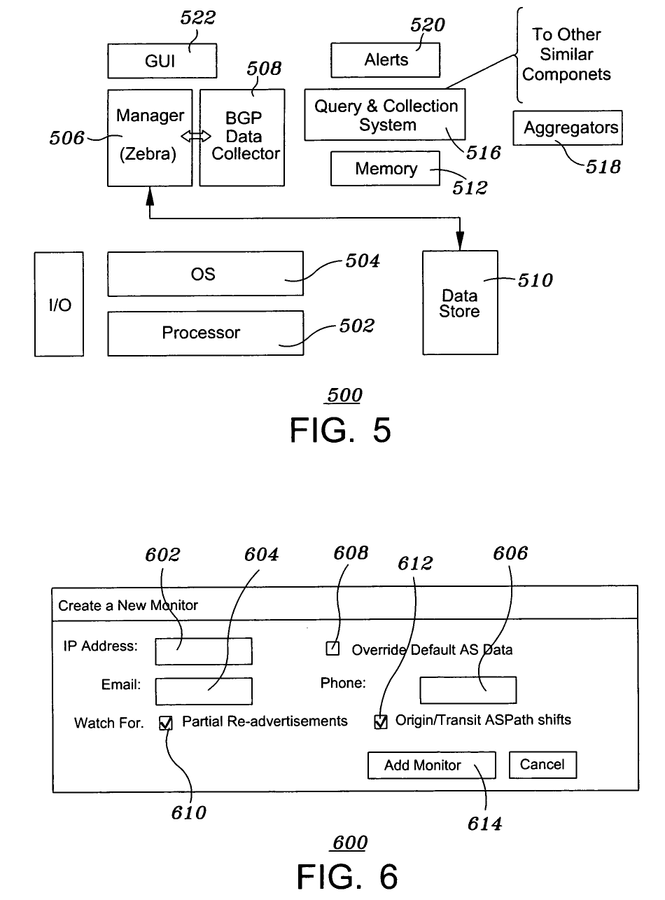

To facilitate the present invention, given machines in the distributed computer system are positioned at locations at or adjacent given network routers. Preferably, these machines are located where the service provider peers with nearby routers, although this is not a requirement. These routers may be third party routers, or routers that are operated by the service provider. As illustrated in FIG. 5, a representative machine 500 comprises commodity hardware (e.g., an Intel Pentium processor) 502 running an operating system kernel (such as Linux) 504 that supports one or more applications including, for example, a manager application 506 that manages TCP/IP based routing protocols, and a BGP data collector 508. Machine 500 also includes an appropriate data store 510 and memory 512. A representative application 506 is Zebra, which is available as open source from Zebra.org. The present invention is not limited for use with machines running Linux and Zebra, of course. With an application such as Zebra running on Linux, the machine can effectively function as a router supporting TCP/IP protocols such as RIPv1, RIPv2, RIPng, OSPFv2, OSPFv3, BGP-4, and BGP-4+. As is well known, such protocols allow routers to speak to each other and share information of paths through a network. Details regarding protocols such as BGP are presumed. Further details about BGP are available at RFC 1771, and further details about Zebra are available at http://www.zebra.org/what.html. The BGP data collector 508 cooperates with the manager application 506 and the adjacent router (not shown) to obtain full or partial BGP data feeds from the router.

In particular, the data collector 508 collects and stores in its associated data store continuous incremental (such as once per hour) data feeds from updates to the routing tables that occur in the nearby router. Periodically, e.g., once per day, a complete (or partial) BGP data “dump” is provided to the NOCC. This data may be delivered electronically or in any other convenient manner, and it may occur in an automated fashion or be accomplished under manual or other administrative control. This “dump” represents a current “known good state” of the BGP routing tables in the router for that period (e.g., a particular day). In one embodiment, a given BGP data collector 508 watches incremental data flows through the associated manager application 506. The known good state is exported to the NOCC directly, preferably daily, so that an aggregate (i.e., bulk) configuration for a set of such collectors can be recomputed on a similar frequency. Real-time views of the BGP data are preferably obtained using a distributed data query and collection system 516 that, as noted above, collects the BGP data feeds from the collectors, aggregates that data across a set of collectors (using, for example, aggregators 518), and passes that data to other back-end systems such as an alerts monitoring system 520. If a relatively small number of data collectors are used, the aggregators may be omitted. Thus, a BGP data collector 508 in a given machine collaborates with similar processes running on other similar machines to provide a distributed data collection application that collects and aggregates BGP data from the distributed network and then exports an interface to provide arbitrary views into that data. The interface 522 preferably also allows system administrators and monitoring tools to view the data from the aggregated collectors in arbitrary ways.

In a preferred embodiment, an alerts monitoring system 520 uses queries (run against the query aggregators 518) to monitor the current (real-time) state of the BGP feeds in the distributed network and to compare such data to given “configuration” information that the system expects to see when operating normally. According to the invention, the real-time and/or known good state BGP data is compared with given configuration data input to the service on behalf of those sites that use the BGP monitoring service. When a comparison between the collected BGP data and the configuration data indicates an anomaly, a given control action (e.g., an alert) is taken. An alert provides a warning of a BGP-based attack, such as an attempt to access sensitive data, an attempt by a third party to masquerade as a given entity, an attempt to generate activity that appears to be originating from a given IP space, and the like. In an illustrative embodiment, a malicious user falsely advertises a route to an organization's IP space, which would trigger all IP traffic (including email, Web traffic, and traffic over higher-level protocols) to be routed to the third party's infrastructure. The invention monitors for occurrence of such an event and provides a given action in response (e.g., the issuance of an alert). According to the present invention, the NOCC preferably exports an integrated GUI tool suite to monitor the alerts as will be illustrated in more detail below. Generally, this suite provides the ability to view any BGP alerts firing on the network.

Users preferably access the service through a secure customer portal, such as an extranet application. After a user logs on and selects a link for the watch service, he or she may “Create a new monitor” to identify an IP “space” to monitor for anomalies. FIG. 6 illustrates a representative display, which may be a form 600. The particular format for this form (or the format of any of the following displays) is not a limitation of the invention, of course. The display form includes an IP address field 602 into which the end user may enter an IP address range it wishes to monitor. Using an email field 604 and/or a telephone number field 606, the end user enters contact information when the alert triggers. A selection box 608 may be selected to override default AS data. Using box 610, the end user may also elect to watch for partial re-advertisements; using box 612 the end user may elect to watch for origin/transmit ASPath shifts. Once the information about what portion of the Internet in entered along with the selection criteria and contact information, the end user selects the “Add Monitor” button 614 to complete the process. Thereafter, the system begins tracking the BGP data feeds provided by the relevant collectors (including, of course, those associated with the IP space) for advertisements that could be problematic.

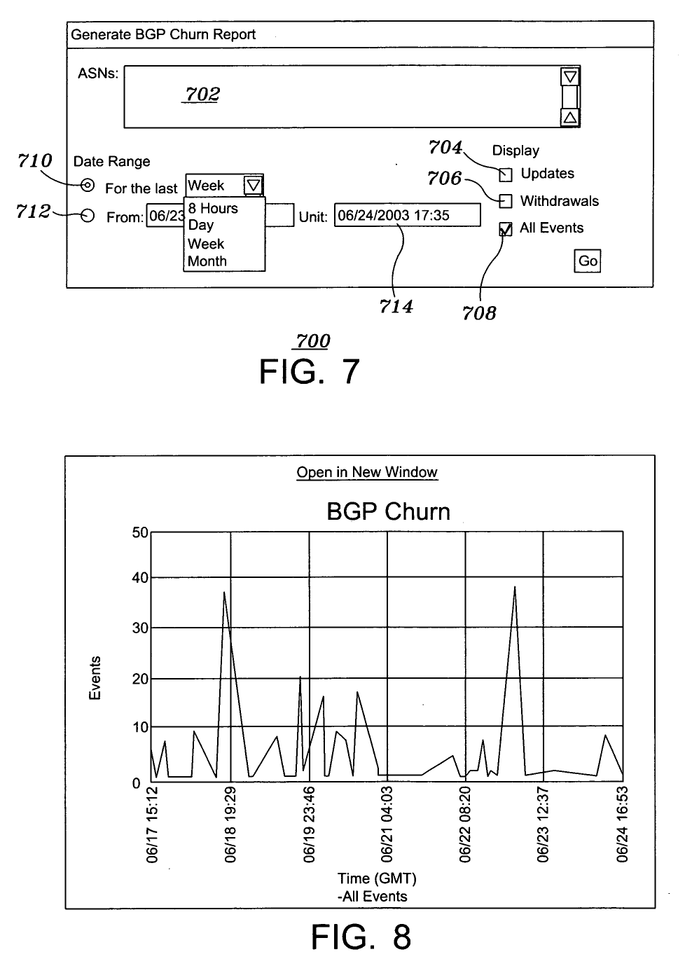

In addition to tracking particular IP ranges for BGP incidents, the watch service may also provide a tool that graphically visualizes historical BGP churn over particular Autonomous System (AS) numbers. This tool enables one to generate a graph of route update activity over time, which is a basic indicator of BGP stability on that section of the Internet. FIG. 7 illustrates a representative form interface by which a user of the present invention can monitor the BGP activity across a variety of different Autonomous Systems. Form 700, which is titled “Generate BGP Churn Report,” includes a number of fields. The user enters AS numbers in the field 702. The user can select various output options using the Updates box 704, the Withdrawals box 706, or the All Events box 708. A date range by selecting a Date Range bullet 710, and then filling in the From field 712 to the Until field 714. An associated drop down list box 712 identifies a desired period. This form thus allows the user to monitor the BGP activity across a variety of different autonomous systems, identifying the relative frequency of updates over a given historical time period.

FIG. 8 illustrates a sample display of BGP churn for a sample set of AS numbers over a timeframe of one week.

In addition, preferably the watch service includes a graphical tool that allows one to enter an AS number and identify the Classless Interdomain Routing (CIDR) blocks advertised as originating in that AS, or to enter an IP address and identify which Autonomous Systems connect to it. As is well known, Classless Interdomain Routing is a technique supported by BGP4 and based on route aggregation. CIDR allows routers to group routes together to cut down on the quantity of routing information carried by the core routers. With CIDR, several IP networks appear to networks outside the group as a single, larger entity. With CIDR, IP addresses and their subnet masks are written as 4 octets, separated by periods, followed by a forward slash and a 2-digit number that represents the subnet mask.

This additional display tool is illustrated in FIG. 9, and it enables a user of the invention to identify CIDR blocks associated with a particular AS number and the numbers connected to a particular IP address through BGP. The display panel 900 includes a field 902 for IP Lookup using a Submit button 904, as well as a field 906 for ASN Lookup using a Submit button 908. Representative displays generated by the tool are also illustrated. If desired, the display may also include a whois query tool.

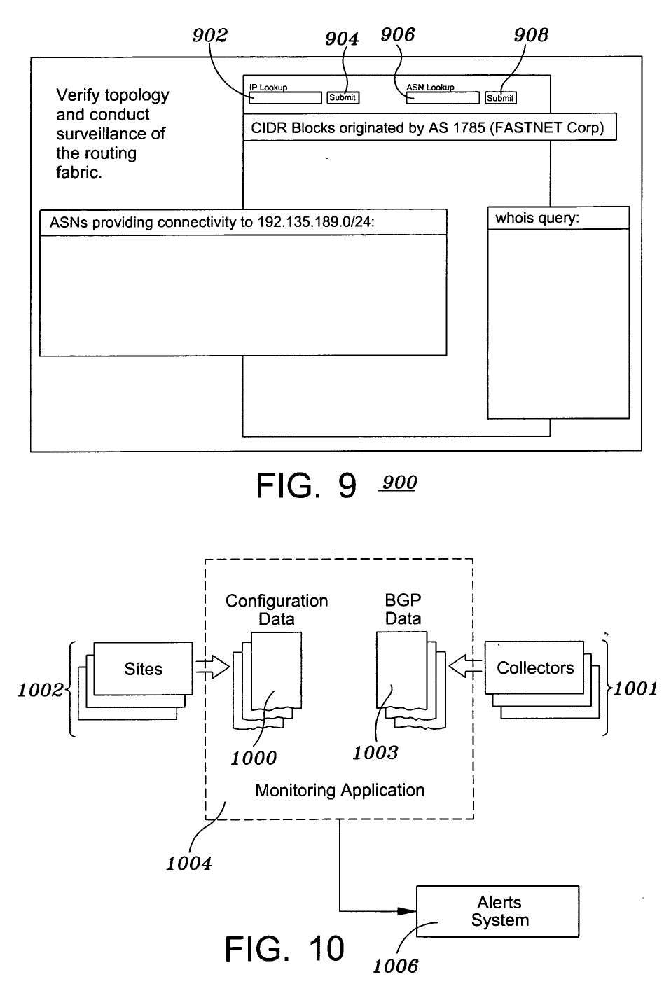

FIG. 10 is a block diagram illustrating the monitoring service. As can be seen, the monitoring service receives as input(s) configuration data. 1000 input from one or more site(s) 1002 that desire to obtain the service, as well as BGP feed data 1003 received from the data collectors 1001. For every origin (IP space) being monitored, a monitoring application 1004 monitors a set of allowed or permitted originating AS numbers for that space. Thus, for every IP address space being watched (i.e., for each routable block that contains an origin server IP address of interest), the monitoring application 1004 continually monitors the set of transit Autonomous Systems for that CIDR block. Using the real-time BGP feeds (and/or the daily updates), the monitoring application 1004 looks for updates coming from the routers that impact the CIDR blocks of interest for that particular customer. When a variance occurs, the monitoring application 1004 sends a message to the alerts system 1006, which then issues a notification to the affected user or takes some other control action. Thus, for example, when a route to a network IP range being tracked is advertised from within some other network, the service identifies where the advertisement originates. This enables the site to detect potential BGP-based attacks and to respond accordingly.

The present invention provides significant advantages. One of ordinary skill in the art may appreciate that the use of a distributed set of collectors, each of which that watch only a portion of a network, an enormous amount of valuable information can be gleaned from the network as a whole. A first data collector peers with a first router to monitor a first IP space, a second data collector peers with a second router to monitor a second IP space, and so forth. Using this approach, a massive amount of BGP feed data is accumulated in a parallel manner, providing for a highly scalable solution. The service further enables individual customers to monitor for BGP discrepancies, churn, performance data changes, quality data changes, cost data changes, and the like, and to provide appropriate alerts when anomalies or other unacceptable behavior occur.

The present invention provides numerous other advantages. At a high level, the inventive technique provides an entity with detailed, unique data about the security and health of an Internet Protocol (IP) space. Organizations may use this data for reporting and analysis to detect several unique types of incidents that are otherwise undetectable. With no comparable source for such security data, the invention helps promote operational continuity, secure online applications, protect an organization's image, and enables more thorough risk assessments.

The data generated by the inventive technique augments security reporting and incident response efforts, improving security and insight amongst various organizational priorities. The technique protects online operations in several ways. For example, it provides significant operational continuity. In particular, BGP attacks can cause serious connectivity issues, resulting in widespread degradations or outages. Early detection using the techniques of the present invention ensures that minimal downtime occurs, if any, and allows for a faster and more targeted response. The invention also provides for significant brand protection for an online presence. As is well known, when communications occur to an audience, including streaming events or mass mailings, there is an opportunity to hijack the valid origin of the content and serve a false, malicious message instead. The present invention identifies when this risk arises and allows for expedient resolution of any incidents.

As another advantage, the invention facilitates secure online applications. In particular, when customers communicate securely over the Internet with an organization, either end of the communication can be legitimately hijacked using BGP exploits. The invention helps identify when such exploits occur, protecting the site customer's experience and security. Further, the invention also facilitates enhanced risk assessment. In particular, individual or large-scale transactions on the Internet carry a certain risk, which amplifies when a BGP attack or other serious issues arise. The inventive technique enables more thorough risk assessments and rapid reporting and response for threats that have materialized.

As previously noted, by using BGP-based attacks, a malicious individual can transparently divert all, or a subset, of a site's IP traffic to another region of the Internet. This traffic can include extremely sensitive data, which may be encrypted, but it can be completely captured and analyzed in depth after the incident. Likewise, with BGP-based attacks, a hacker can generate online activity that appears to be originating from a site's IP space. This allows the attacker to send emails, respond to Web traffic, and engage in any other type of online activity that a site would normally respond. The inventive techniques allow the site operation to know when and where such attacks are occurring, helping it respond effectively with minimal impact to its operations and image.

Providers of secure online services must also be able to trust certain organizations. Some may be merchants, premier customers, or partners, but a site may be blind to various attacks that mimic them. The inventive techniques can be used to provide notice when a specific partner's IP space is hijacked, which can help the site respond to incidents in a timely manner and minimize overall risk.

BGP-based attacks can be used to capture or masquerade traffic, but also have serious implications due to the specifics of BGP and vendor equipment. BGP attacks can render a site's IP space unreachable—effectively stopping any Internet-based activity—causing a loss of continuity of operations. The present invention ameliorates this problem. More generally, the present invention facilitates better overall Internet performance. The Internet has many issues such as inconsistent performance, lack of reliability, and limited security. Although some incidents are not caused by malicious parties, the inventive techniques enable reporting and response to symptoms of degraded performance and reliability.

As has been described, the present invention may be implemented in or in association with a distributed network such as a content delivery network. This is not a limitation, however, as the invention may be practiced in any federated routing infrastructure having a continuous view of BGP data. Implementation within a CDN has many advantages, as such distributed networks typically comprise hundreds if not thousands of servers deployed on over a large number of networks globally. With global deployment across many networks, the CDN service provider may have detailed information about BGP across the entire Internet. Thus, when a route to a network IP range being tracked is advertised from within any network around the world, the present invention can identify where the advertisement originates. BGP alone does not inherently have any reporting or security mechanisms to protect an organization from misuse. With the present invention, there is a means to detect BGP-based attacks and provide the ability to respond appropriately, thereby limiting potential damage.

Finally, the present invention enables insight into a potentially crippling method of Internet attacks—BGP-based IP hijacking. There is no means to effectively track such information without the present invention, leaving any IP-based application at risk for severe exploits. The invention allows a site to protect its online operations and provides a level of insight critical for maintaining the utmost in security.

The present invention provides a set of easy and powerful tools to rapidly detect and respond to BGP incidents. By leveraging a distributed network's insight into the Internet and BGP, the invention can help protect against incidents that could result in theft of customer data, destruction of brand equity, and extended outages for all online activity.

While the present invention has been described in the context of BGP, this is not a limitation. The invention may be implemented in any distributed computer network that is provided as an overlay to a set of heterogenous IP-based networks and where a given routing protocol is used to provide federated routing.

1. A method of monitoring, operative in a distributed computer network that overlays a set of heterogenous networks, comprising:
at each of a given set of locations in the distributed computer network, collecting routing data;
for a given IP address space, using the routing data to determine whether a given event has occurred within the given IP address space;
if the given event has occurred within the given IP address space, taking a given action.

2. The method as described in claim 1 wherein the given event is a diversion of IP traffic intended for the given IP address space.

3. The method as described in claim 1 wherein the given event is an entity falsely advertising a route to the given IP address space.

4. The method as described in claim 1 wherein the given action is issuance of an alert.

5. The method as described in claim 1 wherein the routing data is Border Gateway Protocol (BGP) data.

6. The method as described in claim 1 further including the step of:
aggregating the BGP data from a given subset of the given set of locations on a real-time basis.

7. The method as described in claim 6 further including the step of: exporting a view of the aggregated BGP data.

8. The method as described in claim 1 further including the step of:
periodically exporting a view of the routing data as a known state.

9. A method of monitoring, operative in a distributed computer network that overlays a set of heterogenous networks, comprising:
enabling each of a set of users to identify a given set of IP addresses within a given IP address space that are to be monitored;
for each of the given IP address spaces that are to be monitored, tracking Border Gateway Protocol (BGP) data for routing advertisements that are associated with at least one given routing anomaly; and
taking a given action upon occurrence of the given routing anomaly.

10. The method as described in claim 9 wherein the given routing anomaly is a misconfiguration.

11. The method as described in claim 9 wherein the given routing anomaly is a blocked route advertisement or withdrawal.

12. The method as described in claim 9 wherein the given routing anomaly is a diversion of IP traffic intended for the given IP address space.

13. The method as described in claim 9 further including the step of:
aggregating the BGP data on a real-time basis.

14. A Border Gateway Protocol (BGP) data watch system, operative in a distributed computer network that overlays a set of heterogenous networks, comprising:
code for generating a first display that enables a given user to identify a given IP address space that is to be monitored; and
code for generating a second display that enables a given user to identify for display BGP route update data over a given Autonomous System (AS) over a given historical time period.

15. The BGP data watch system as described in claim 14 further including:
code for displaying the BGP route update data over the given AS over the given historical time period.

16. The BGP data watch system as described in claim 14 wherein the first display includes a field for selecting partial re-advertisements.

17. The BGP data watch system as described in claim 14 wherein the first display includes a field for selecting origin/transmit AS Paths.

18. The BGP data watch system as described in claim 14 wherein the first display includes an alert notification field.
